(19) United States
(12) Patent Application Publication
(10) Pub. No.: US 2024/0296338 A1
(43) Pub. Date: Sep. 5, 2024

(54) METHOD AND SYSTEM FOR GENERATING TRANSFER LEARNING MODEL BASED ON CONVERGENCE OF MODEL COMPRESSION AND TRANSFER LEARNING

(71) Applicant: NOTA, INC., Daejeon (KR)

(72) Inventor: Seul Ki YEOM, Gwangju (KR)

(73) Assignee: NOTA, INC., Daejeon (KR)

(21) Appl. No.: 18/454,466

(22) Filed: Aug. 23, 2023

(30) Foreign Application Priority Data
Mar. 3, 2023 (KR) 10-2023-0028330

(51) Int. Cl. G06N 3/096

(52) U.S. Cl. CPC G06N 3/096

(57) ABSTRACT

Provided are a method and system for generating a transfer learning model based on convergence of model compression and transfer learning convergence. The method of generating a transfer learning model may include reconstructing a first model that is pre-trained based on a first dataset, and generating a second model by removing at least some weights from the reconstructed first model based on a second dataset that is different from the first dataset, and generating the second model that is trained with transfer learning by using the second dataset, from the first model from which the at least some weights are removed.

### CROSS-REFERENCE TO RELATED APPLICATION

This application is based on and claims priority under 35 U.S.C. § 119 to Korean Patent Application No. 10-2023-0028330, filed on Mar. 3, 2023, in the Korean Intellectual Property Office, the disclosure of which is incorporated by reference herein in its entirety.

### BACKGROUND

### 1. Field

Embodiments of the present disclosure relate to methods and systems for generating a transfer learning model based on convergence of model compression and transfer learning.

### 2. Description of the Related Art

Deep learning models have much higher accuracy than other existing techniques, and thus are applicable to numerous fields such as computer vision or natural language processing. However, there is a major correlation between accuracy improvement and model size, and for this reason, interest in compression techniques that require a small storage space and amount of computation but enable high-speed inference is growing. In particular, pruning, which is one of the model compression methods, is a method of finding and removing weights or neurons that are relatively insignificant for a trained model to perform a target task. Pruning is for preparing a pre-trained model first and improving an existing inefficient model network structure through a compression technique, and enables a great improvement in the amount of computation and the number of parameters compared to an existing model.

Meanwhile, in order for a deep learning model to perform accurate computations, an enormous increase in the amount of computation is required, which results in an increase in the training time that is in proportion to the amount of computation. In addition, the increased training time is also problematic in terms of energy. That is, the amount of electricity consumed by computational resources required for training increases, and models showing excellent performance in recent years inevitably require a larger amount of computation and a longer training time due to a large number of parameters. One of alternative solutions to this issue is transfer learning. Transfer learning is “a method of using knowledge and information obtained for solving a problem in one field to solve another problem”, and refers to a learning method in which information (source) obtained through learning for a long time is transferred, rather than performing learning for a new task for a long time from the beginning. In particular, transfer learning has proven to be more effective when data is insufficient, than existing techniques.

### PRIOR DOCUMENT NUMBER

Korean Patent Publication No. 10-2022-0142194

### SUMMARY

Provided are methods and systems for efficiently converging a model compression technique and a transfer learning technique, which have been developed as independent techniques, to simultaneously gain independent advantages of the two techniques.

Additional aspects will be set forth in part in the description which follows and, in part, will be apparent from the description, or may be learned by practice of the presented embodiments of the disclosure.

Provided is a method, performed by a computer device including at least one processor, of generating a transfer learning model, the method including reconstructing, by the at least one processor, a first model that is pre-trained based on a first dataset, and generating, by the at least one processor, a second model by removing at least some weights from the reconstructed first model based on a second dataset that is different from the first dataset, and generating the second model that is trained with transfer learning by using the second dataset, from the first model from which the at least some weights are removed.

According to an aspect, the generating of the second model may include inputting the second dataset to the reconstructed first model, determining weights to be removed from the reconstructed first model using a result of the inputting the second dataset, removing the determined weights from the reconstructed first model, and generating the second model by training the first model from which the weights are removed, based on the second dataset, wherein the second dataset is configured for a target task of the transfer learning different from a task of the first model and includes data different from data used to pre-train the first model.

According to another aspect, the generating of the second model may include determining, from among the weights of the reconstructed first model, the at least some weights to be removed from the first model, based on degrees to which the weights of the reconstructed first model are activated in response to the second dataset being input into the reconstructed first model.

According to another aspect, the generating of the second model may further include determining, as the at least some weights to be removed from the first model, weights of which the degrees to which the weights are activated are less than or equal to a threshold value.

According to another aspect, the threshold value may be determined based on at least one of performance of target hardware, an amount of computation allowed for the second model, and a number of parameters allowed for the second model.

According to another aspect, the generating of the second model may include generating the second model by using a pruning mask that minimizes a loss function that considers a loss difference before and after removing the at least some weights from the reconstructed first model, and a difference between a target hardware resource and a hardware resource of the first model from which the at least some weights are removed.

According to another aspect, the reconstructing of the first model may include reconstructing the first model according to a target task to be transferred.

According to another aspect, the second dataset may include a dataset for a target task to be transferred.

Provided is a computer program stored in a computer-readable recording medium to be combined with a computer device to execute the method on the computer device.

Provided is a computer-readable recording medium having recorded thereon a program for executing the method on a computer device.

Provided is a computer device including at least one processor configured to execute instructions readable by the computer device, wherein the at least one processor is further configured to reconstruct a first model that is pre-trained based on a first dataset, and generate a second model by removing at least some weights from the reconstructed first model based on a second dataset that is different from the first dataset, and generating the second model that is trained with transfer learning by using the second dataset, from the first model from which the at least some weights are removed.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an example of a computer device according to an embodiment of the present disclosure;

FIG. 2 is a flowchart illustrating an example of a method of generating a transfer learning model, according to an embodiment of the present disclosure;

FIG. 3 is a diagram illustrating an example of a transfer learning process with model compression, according to an embodiment of the present disclosure;

FIG. 4 is a diagram illustrating an example of a source model that is pre-trained for a first task;

FIG. 5 is a diagram illustrating an example of a model generated by applying a pruning technique to a source model;

FIG. 6 is a diagram illustrating an example of a model generated by applying transfer learning to a source model; and

FIG. 7 is a diagram illustrating an example of a model generated by applying, to a source model, a method of generating a transfer learning model according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments will be described in detail with reference to the accompanying drawings.

A system for generating a transfer learning model according to embodiments of the present disclosure may be implemented by at least one computer device, and a method of generating a transfer learning model according to embodiments of the present disclosure may be performed by at least one computer device included in the system for generating a transfer learning model. A computer program according to an embodiment of the present disclosure may be installed in and executed by a computer device, and the computer device may perform the method of generating a transfer learning model according to embodiments of the present disclosure under control of the executed computer program. The computer program may be stored in a computer-readable recording medium to be combined with the computer device to execute the method of generating a transfer learning model on the computer device.

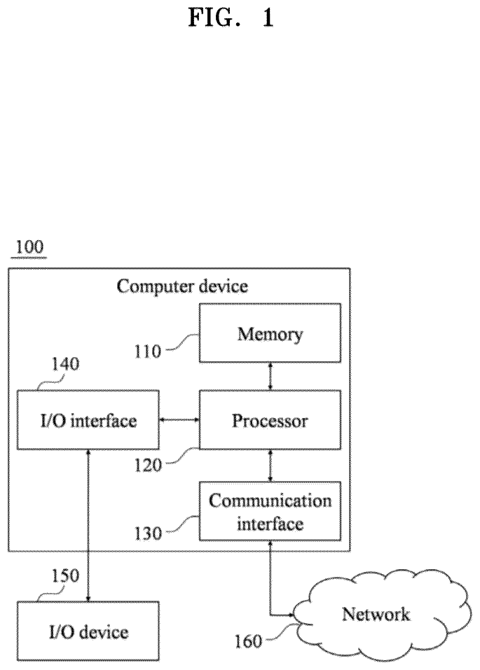

FIG. 1 is a block diagram illustrating an example of a computer device according to an embodiment of the present disclosure. As illustrated in FIG. 1, a computer device 100 may include a memory 110, a processor 120, a communication interface 130, and an input/output (I/O) interface 140. The memory 110 is a computer-readable recording medium and may include a permanent mass storage device such as random-access memory (RAM), read-only memory (ROM), or a disk drive. Here, the permanent mass storage device such as a ROM or a disk drive may be included in the computer device 100 as a permanent storage device separate from the memory 110. In addition, an operating system and at least one piece of program code may be stored in the memory 110. These software components may be loaded into the memory 110 from a computer-readable recording medium separate from the memory 110. The separate computer-readable recording medium may include a computer-readable recording medium such as a floppy drive, a disk, a tape, a digital video disc (DVD)/compact disc (CD) ROM (CD-ROM) drive, or a memory card. In another embodiment, the software components may be loaded into the memory 110 through the communication interface 130 rather than a computer-readable recording medium. For example, the software components may be loaded into the memory 110 of the computer device 100 based on a computer program installed by files received through a network 160.

The processor 120 may be configured to process a command of a computer program by performing basic arithmetic, logic, and input/output operations. The command may be provided to the processor 120 by the memory 110 or the communication interface 130. For example, the processor 120 may be configured to execute a received command according to program code stored in a recording device such as the memory 110.

The communication interface 130 may provide a function of allowing the computer device 100 to communicate with other devices through the network 160. For example, a request, a command, data, a file, or the like generated by the processor 120 of the computer device 100 according to program code stored in a recording device such as the memory 110 may be transmitted to other devices through the network 160 under control of the communication interface 130. Conversely, signals, commands, data, files, or the like from other devices may be received by the computer device 100 through the communication interface 130 of the computer device 100 via the network 160. Signals, commands, data, or the like received through the communication interface 130 may be transmitted to the processor 120 or the memory 110, and files or the like received through the communication interface 130 may be stored in a storage medium (e.g., the above-described permanent storage device) that may be further included in the computer device 100.

The I/O interface 140 may be a unit for interfacing with an I/O device 150. For example, the input device may include a device such as a microphone, a keyboard, or a mouse, and the output device may include a device such as a display or a speaker. As another example, the I/O interface 140 may be a unit for interfacing with a device in which functions for input and output are integrated, such as a touch screen. The I/O device 150 and the computer device 100 may be configured as one device.

In addition, in other embodiments, the computer device 100 may include fewer or more components than those illustrated in FIG. 1. However, most of the related components may not necessarily require exact illustration. For example, the computer device 100 may include at least a portion of the I/O device 150 or may further include other components such as a transceiver or a database.

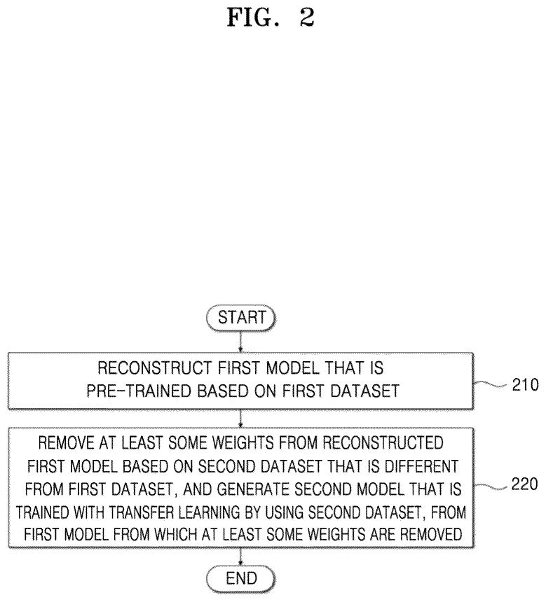

FIG. 2 is a flowchart illustrating an example of a method of generating a transfer learning model, according to an embodiment of the present disclosure. The method of generating a transfer learning model according to the present embodiment may be performed by the computer device 100 described above with reference to FIG. 1. Here, the processor 120 of the computer device 100 may be implemented to execute control instructions according to code of an operating system or code of at least one computer program included in the memory 110. Here, the processor 120 may control the computer device 100 to perform operations 210 and 220 included in the method of FIG. 2, according to control instructions provided by code stored in the computer device 100.

In operation 210, a computer device 100 may reconstruct a first model that is pre-trained based on a first dataset. For example, the computer device 100 may reconstruct the first model according to a target task to be transferred. The pre-trained first model may include a backbone and heads, each trained based on the first dataset. Here, the computer device 100 may reconstruct the first model by maintaining the backbone of the first pre-trained model as it is, and replacing the heads of the first model that is pre-trained based on the first dataset, with reconstructed head as many as the number of classes included in a second dataset.

In operation 220, the computer device 100 may remove at least some weights from the reconstructed first model based on the second dataset that is different from the first dataset, and generate a second model that is trained with transfer learning by using the second dataset, from the first model from which at least some weights are removed. Here, the computer device 100 may determine weights to be removed from the reconstructed first model, by inputting part or all of the second dataset into the reconstructed first model. In other words, the computer device 100 may input the second dataset to the reconstructed first model, may determine weights to be removed from the reconstructed first model using the result of the inputting of the second dataset, and may then remove the determined weights from the reconstructed first model. For example, the computer device 100 may determine, from among weights of the reconstructed first model, at least some weights to be removed from the first model, based on the degree to which the weights of the reconstructed first model are activated as a result of inputting part or all of the second dataset. Here, the second dataset may include a dataset for a target task to be transferred. In other words, the computer device 100 may calculate the degree to which the weights of the first model are activated, by inputting, into the first model, part or all of a training dataset for performing transfer learning on the first model according to the target task. In this case, the computer device 100 may determine, as weights to be removed, weights whose degree to which the weights are activated is less than or equal to a threshold value. Here, the threshold value may be determined based on the performance of target hardware, the amount of calculation allowed for the second model, and/or the number of parameters allowed for the second model. Then, the computer device 100 may remove the determined weights from the reconstructed first model. In addition, the computer device 100 may generate the second model by training the first model from which the weights are removed, based on the second dataset.

The computer device 100 may determine weights to be removed from the reconstructed first model, by inputting part or all of the second dataset into the reconstructed first model and using a pruning mask. In other words, the computer device 100 may input part or all of the second dataset into the reconstructed first model, and based on the results of this inputting, the computer device 100 may obtain the pruning mask. The computer device 100 may then generate the second model by using the pruning mask that minimizes a loss function considering a loss difference before and after removing at least some weights of the reconstructed first model, and a difference between a target hardware resource and a hardware resource of the first model from which at least some weights are removed. For example, Equation 1 below shows a loss function [symbol] considering a loss difference between the first model before pruning and the first model after pruning, and a difference between a predefined target hardware resource and a hardware resource of the compressed first model on which pruning has been performed, and shows a second model f′ that minimizes the loss function [symbol] .

[Equation 1]

$$\begin{matrix}ℒ ← {ℒ}_{CE} ( f ( X ; Λ ) ) + {βℒ}_{g} ( Λ ) \\ {f}^{′} = {arg min}_{Λ} ℒ\end{matrix}$$

Here, in Equation 1, [symbol] _{CE}(f( [symbol] ; Λ)) may be a term that considers a loss difference before and after performing pruning on a first model f using input data (e.g, second dataset) [symbol] and a virtual pruning mask Λ, by using a cross-entropy loss [symbol] _{CE}. In addition, β [symbol] _{g}(Λ) may be a term that considers a difference in hardware resources (floating point operations per second (FLOPs)). Here, the finally generated second model f′ may be designed through a pruning mask Λ obtained through normalization that minimizes the loss function [symbol] . For example, in a normalization process, the computer device 100 may obtain the pruning mask Λ that minimizes the loss function [symbol] by repeatedly performing pseudo pruning for masking weights. The second model f′ may be generated by removing, from the first model f, weights masked based on the obtained pruning mask Λ.

As described above, the model compression technique and the transfer learning technique have been developed as techniques that are significantly efficient but independent of each other. The pruning technique is excellent in terms of compression, but has limitations in terms of scalability in designing a task-aware model, and the transfer learning technique has a disadvantage that a finally trained model still has a high amount of computation and a large number of parameters.

In embodiments of the present disclosure, it is possible to simultaneously gain independent advantages by simply converging the model compression technique and the transfer learning technique, and thus, availability for general purposes may be achieved. For example, a compressed model that is optimized for a given task may be generated by reducing a large model into a small model and simultaneously performing pruning to leave only important information. Here, independent advantages of model compression and transfer learning may be simultaneously generated by inputting part or all of a training dataset (the second dataset) for a target task into a first model reconstructed in a process of transfer learning, to determine weights having low degrees of activation, then removing the determined weights from the first model, then training the first model from which the weights are removed, based the training dataset to generate a second model that is trained with transfer learning, rather than simply performing model compression and transfer learning separately from each other.

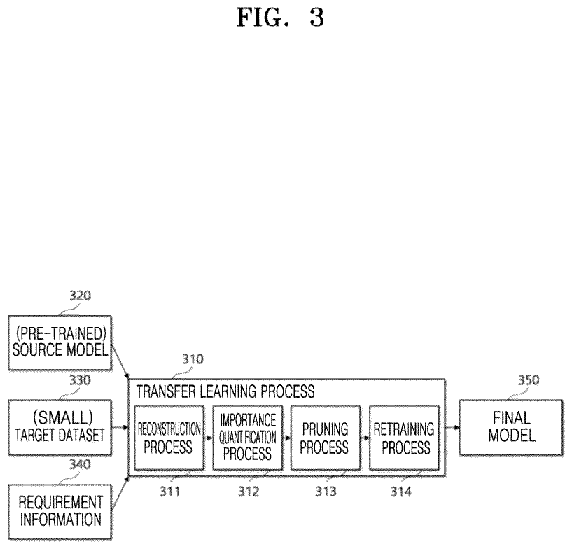

FIG. 3 is a diagram illustrating an example of a transfer learning process with model compression, according to an embodiment of the present disclosure. Inputs for a transfer learning process 310 may include a pre-trained source model 320, a small target dataset 330, and requirement information 340. Here, the pre-trained source model 320 may correspond to, for example, the first model described above with reference to FIG. 2, and the small target dataset 330 is a training dataset for a target task and may correspond to the second dataset described above with reference to FIG. 2. Transfer learning generally assumes an environment in which a dataset for a target task is not sufficient, as a basic scenario. In other words, transfer learning may be performed such that knowledge (the pre-trained source model 320) learned from a “large amount” of data is utilized for a task for which only a “small amount” of data is available. As such, the term “small” in the small target dataset 330 may mean a relatively small amount compared to a dataset for pre-training of the pre-trained source model 320. The requirement information 340 may include the performance of target hardware on which a final model 350, which is trained with transfer learning, is to operate, the amount of computation allowable for the final model 350, and/or the number of parameters allowable for the final model 350.

A reconstruction process 311 may be an example of a process of reconstructing the pre-trained source model 320 for a second task by using a first dataset for a first task. As described above, reconstruction may be performed in such a manner that the backbone of the pre-trained source model 320 is maintained as it is, and the heads of the source model 320 that is pre-trained based on the first dataset are replaced with reconstructed heads as many as the number of classes included in the second dataset.

An importance quantification process 312 may be an example of a process of quantifying the importance of each weight of the source model 320. The source model 320 in descriptions of processes after the importance quantification process 312 may refer to a reconstructed model on which the reconstruction process 311 has been performed. As described above, the computer device 100 may input part or all of the target dataset 330 into the source model 320 to identify the degree of activation of each weight. Here, the importance of the weight may be quantified according to the degree of activation. For example, the computer device 100 may determine that the importance of weights whose degrees of activation are less than or equal to a threshold value is low, and thus remove the weights. Here, the threshold may be set based on the requirement information 340. For example, as the performance of the target hardware on which the final model 350 is to operate increases, as the amount computation allowable for the final model 350 increases, and as the number of parameters allowable for the final model 350 increases, the threshold value may set relatively larger.

A pruning process 313 may be an example of a process of pruning weights according to the quantified importance in the source model 320. For example, the computer device 100 may prune and remove the weights determined in the importance quantification process 312, from the source model 320. The source model 320 in descriptions of processes after the pruning process 313 may refer to a model to which pruning has been applied through the pruning process 313.

The retraining process 314 may be an example of a process of retraining the source model 320 to generate the final model 350 as a model that is trained with transfer learning with respect to the source model 320. For example, in order to train, with training data, the source model 320 that is pre-trained based on the training dataset for the first task (e.g., the first dataset described above with reference to FIG. 2) into the final model 350 for the second task, the computer device 100 may generate the final model 350 by retraining the source model 320 by using the target dataset 330, which is a training dataset for the second task.

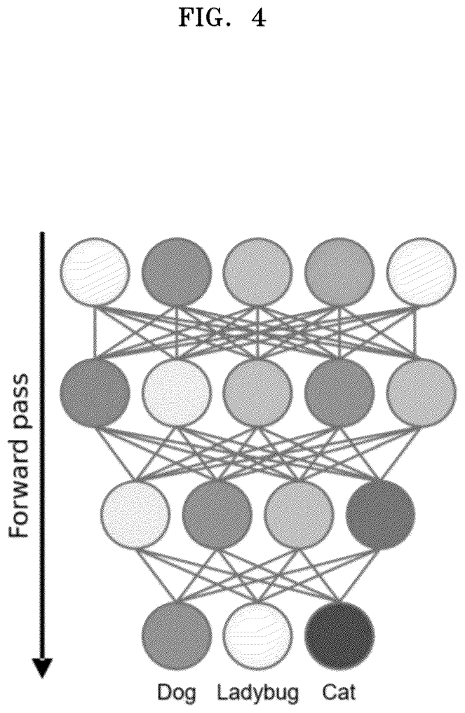

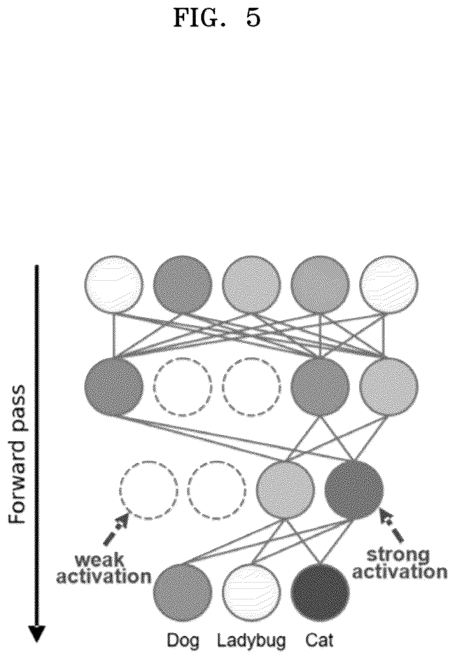

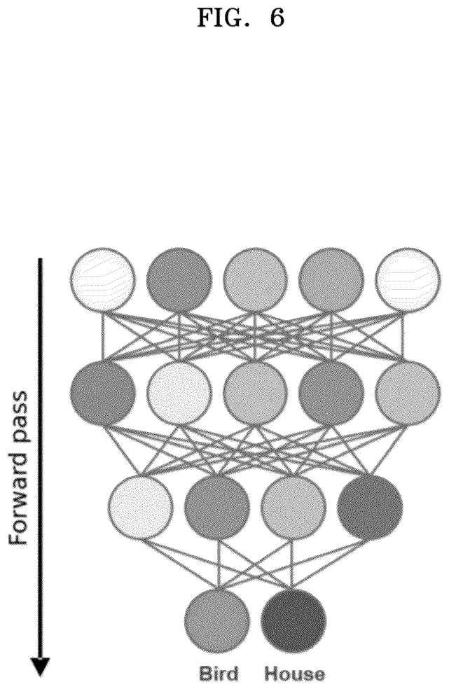

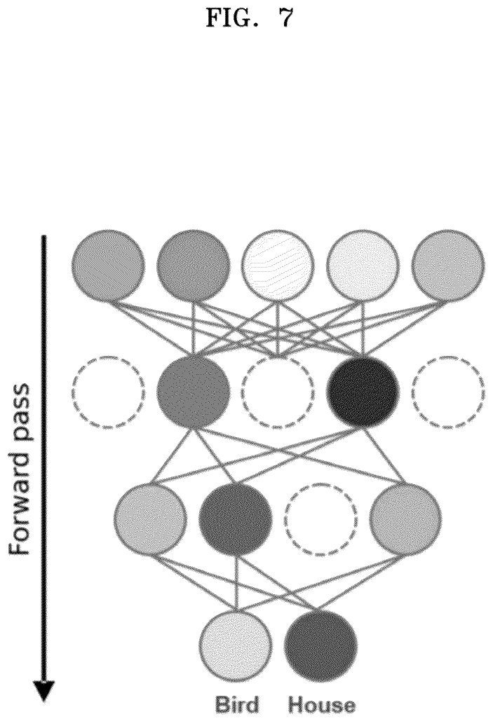

FIG. 4 is a diagram illustrating an example of a source model that is pre-trained for a first task, FIG. 5 is a diagram illustrating an example of a model generated by applying a pruning technique to a source model, FIG. 6 is a diagram illustrating an example of a model generated by applying transfer learning to a source model, and FIG. 7 is a diagram illustrating an example of a model generated by applying, to a source model, a method of generating a transfer learning model according to an embodiment of the present disclosure. In FIGS. 4 to 7, circles represent nodes constituting the model, and brightness of the inside of each circle may represent the importance of the node. Here, as the brightness of the inside of the circle decreases, the importance of the corresponding node increases. The importance may be determined by the degree of activation of the weight.

Here, FIG. 4 illustrates an example of a source model that is pre-trained for the first task of distinguishing between dogs, ladybugs, and cats in an image, and FIG. 5 illustrates an example in which a compressed model for the first task of distinguishing between dogs, ladybugs, and cats is generated by pruning nodes of the source model of FIG. 4 according to activation-based importance. FIG. 6 illustrating an example in which a target model for a second task of distinguishing between birds and houses in an image is generated by performing transfer learning on the source model of FIG. 4. Such a target model may be generated by retraining the source model based on a training dataset for the second task.

FIG. 7 illustrates an example of a model generated by applying, to the source model of FIG. 4, the method of generating a transfer learning model according to an embodiment of the present disclosure. Here, the model of FIG. 7 refers to a compressed model for the second task of distinguishing between birds and houses in an image.

In a case in which transfer learning is performed simply after performing pruning, transfer learning for the second task is performed in a state in which weights are removed according to the importance based on criterion for the first task, and thus, the performance of the model for the completely independent second task may deteriorate after compression for the first task. Conversely, in a case in which pruning is performed after performing transfer learning, the cost for transfer learning may increase because transfer learning is performed on the entire source model. In addition, in a case in which pruning and transfer learning are performed separately from each other, two retraining processes including retraining after the pruning and retraining after the transfer learning are required.

On the contrary, in embodiments of the present disclosure, because compression and transfer learning are performed simultaneously and the importance of weights is determined by using the training dataset for the second task, all independent advantages of the compression and the transfer learning may be obtained. In addition, as compression and transfer learning are performed simultaneously, a model that is compressed and trained with transfer learning may be generated through one retraining process.

As such, according to embodiments of the present disclosure, by efficiently converging a model compression technique and a transfer learning technique, which have been developed as independent techniques, it is possible to gain independent advantages of the two techniques simultaneously.

The systems or devices described above may be implemented with a hardware component or a combination of a hardware component and a software component. For example, the devices and components described in the embodiments may be implemented by using one or more general-purpose computers or special-purpose computers, such as a processor, a controller, an arithmetic logic unit (ALU), a digital signal processor, a microcomputer, a field-programmable gate array (FPGA), a programmable logic unit (PLU), a microprocessor, or any other device configured to execute and respond to instructions. The processor may execute an operating system (OS) and one or more software applications running on the OS. The processor may also access, store, modify, process, and generate data in response to execution of software. Although some embodiments are described, for convenience of understanding, with reference to examples in which a single processor is used, those of skill in the art would understand that a processor may include a plurality of processing elements and/or a plurality of types of processing elements. For example, the processor may include one or more processors and one controller. In addition, other processing configurations are also possible, such as a parallel processor.

The software may include a computer program, code, instructions, or a combination of one or more thereof, and may configure the processor to operate as desired or may independently or collectively instruct the processor. Software and/or data may be embodied permanently or temporarily in any type of machine, component, physical or virtual equipment, computer storage medium, or device, for providing instructions or data to or being interpreted by the processor. The software may be distributed on networked computer systems and stored or executed in a distributed manner. The software and data may be stored in one or more computer-readable recording media.

The method according to an embodiment may be embodied as program commands executable by various computer devices, and recorded on a computer-readable medium. The computer-readable medium may include program instructions, data files, data structures, or the like separately or in combinations. The medium may permanently store the computer-executable programs, or store the computer-executable programs for execution or downloading. In addition, the medium may be any one of various recording media or storage media in which a single piece or plurality of pieces of hardware are combined, and the medium is not limited to a medium directly connected to a computer system, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software. Examples of the program instructions include not only machine code, such as code made by a compiler, but also high-level language code that is executable by a computer by using an interpreter or the like.

Although the embodiments have been described with the limited embodiments and the drawings, various modifications and changes may be made by those of skill in the art from the above description. For example, the described techniques may be performed in a different order from the described method, and/or components of the described system, structure, device, circuit, etc. may be combined or integrated in a different form from the described method, or may be replaced or substituted by other components or equivalents to achieve appropriate results.

Therefore, other implementations or embodiments, and equivalents of the following claims are within the scope of the claims.

By efficiently converging a model compression technique and a transfer learning technique, which have been developed as independent techniques, it is possible to simultaneously gain independent advantages of the two techniques.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

1. A method, performed by a computer device comprising at least one processor, of generating a transfer learning model, the method comprising:
reconstructing, by the at least one processor, a first model that is pre-trained based on a first dataset; and
generating, by the at least one processor, a second model by removing at least some weights from the reconstructed first model based on a second dataset that is different from the first dataset, and generating the second model that is trained with transfer learning by using the second dataset, from the first model from which the at least some weights are removed.

2. The method of claim 1, wherein the generating of the second model comprises:
inputting, the second dataset to the reconstructed first model,
determining weights to be removed from the reconstructed first model using a result of the inputting the second dataset,
removing the determined weights from the reconstructed first model, and
generating the second model by training the first model from which the weights are removed, based on the second dataset,
wherein the second dataset is configured for a target task of the transfer learning different from a task of the first model and includes data different from data used to pre-train the first model.

3. The method of claim 1, wherein the generating of the second model comprises determining, from among the weights of the reconstructed first model, the at least some weights to be removed from the first model, based on degrees to which the weights of the reconstructed first model are activated in response to the second dataset being input into the reconstructed first model.

4. The method of claim 3, wherein the generating of the second model further comprises determining, as the at least some weights to be removed from the first model, weights of which the degrees to which the weights are activated are less than or equal to a threshold value.

5. The method of claim 4, wherein the threshold value is determined based on at least one of performance of target hardware, an amount of computation allowed for the second model, and a number of parameters allowed for the second model.

6. The method of claim 1, wherein the generating of the second model comprises generating the second model by using a pruning mask that minimizes a loss function that considers a loss difference before and after removing the at least some weights from the reconstructed first model, and a difference between a target hardware resource and a hardware resource of the first model from which the at least some weights are removed.

7. The method of claim 1, wherein the reconstructing of the first model comprises reconstructing the first model according to a target task to be transferred.

8. A computer-readable recording medium having recorded thereon a program for executing, on a computer device, the method of claim 1.

9. A computer device comprising at least one processor configured to execute instructions readable by the computer device,
wherein the at least one processor is further configured to reconstruct a first model that is pre-trained based on a first dataset, and generate a second model by removing at least some weights from the reconstructed first model based on a second dataset that is different from the first dataset, and generating the second model that is trained with transfer learning by using the second dataset, from the first model from which the at least some weights are removed.

10. The computer device of claim 9, wherein, in order to generate the second model, the at least one processor is further configured to determine weights to be removed from the reconstructed first model by inputting the second dataset into the reconstructed first model, remove the determined weights from the reconstructed first model, and generate the second model by training the first model from which the weights are removed, based on the second dataset.

11. The computer device of claim 9, wherein, in order to generate the second model, the at least one processor is further configured to determine, from among the weights of the reconstructed first model, the at least some weights to be removed from the first model, based on degrees to which the weights of the reconstructed first model are activated in response to the second dataset being input into the reconstructed first model.

12. The computer device of claim 9, wherein, in order to generate the second model, the at least one processor is further configured to generate the second model by using a pruning mask that minimizes a loss function that considers a loss difference before and after removing the at least some weights from the reconstructed first model, and a difference between a target hardware resource and a hardware resource of the first model from which the at least some weights are removed.

13. The computer device of claim 9, wherein, in order to reconstruct the first model, the at least one processor is further configured to reconstruct the first model according to a target task to be transferred.
